(19) United States
(12) Patent Application Publication
(10) Pub. No.: US 2025/0039136 A1
(43) Pub. Date: Jan. 30, 2025

(54) FAST NON-INTRUSIVE VERIFICATION OF FIREWALL CODE/POLICY UPDATES FOR CONTINUOUS INTEGRATION, CONTINUOUS DEPLOYMENT (CI/CD)

(71) Applicant: Cisco Technology, Inc., San Jose, CA (US)

(72) Inventor: John Michael Lake, Cary, NC (US)

(21) Appl. No.: 18/782,949

(22) Filed: Jul. 24, 2024

Related U.S. Application Data
(60) Provisional application No. 63/516,448, filed on Jul. 28, 2023.

(51) Int. Cl. H04L 9/40; H04L 43/50

(52) U.S. Cl. CPC H04L 63/0236; H04L 43/50; H04L 63/20

(57) ABSTRACT

A system and method are provided for continuous integration, continuous deployment of a network component, such as a software-defined wide area network, a firewall, a router, or a load balancer. The network component is tested before deployment by acquiring data flows from a production environment and obtaining an acquired flow table that includes respective entries corresponding to types of data flows that are defined by header information (e.g., 5-tuples or pairs of source and destination addresses, depending at which layer in the OSI model the network component operates). First and second flow tables are generated for the first and second versions of the network component by applying simulated traffic (e.g., derived from the acquired data flows) to the respective versions of the network component. A comparison between the first and second flow tables is evaluated to determine whether second version of the network component can be deployed.

### CROSS-REFERENCE TO RELATED APPLICATIONS

This application priority to U.S. provisional application No. 63/516,448, titled “Data Processing Units (DPUs) and extended Berkley Packet Filters (eBPFs) for Improved Security,” and filed on Jul. 28, 2023, which is expressly incorporated by reference herein in its entirety.

### BACKGROUND

Roll-out and deployments of upgrades to software and/or policies in network components (also referred to as network devices) can encounter unexpected problems such as bugs that require rollback to a previous version of the software and/or policies. To minimize unexpected problems during roll-out, testing can be performed in a testing environment prior to deploying the upgrades in a production environment. By detecting bugs during testing and before deployment of the upgrade, the disruption and effort of deploying upgrades can be minimized.

For infrastructure and devices at the network edge (e.g., SD-WAN appliances, firewalls, and load balancers), upgrades and maintenance can be disruptive to users. For example, upgrading embedded devices at the network edge can introduce downtime due to device failover and/or route re-convergence. Accordingly, infrastructure upgrades can require a scheduled maintenance window. Additionally, infrastructure upgrades can involve pre- and post-upgrade checks to ensure that the new software or policy does not negatively affect the network. In case the upgrade fails, infrastructure upgrades can include rollback and other contingency plans. In-house testing can be performed before the deployment/production phase. However, in-house testing may fail to identify issues due to differences between the in-house settings/environment and the production settings/environment.

In software and networking infrastructure upgrades various methods can be used when testing and deploying new versions (e.g., upgrades). The various methods can be used to test the upgrades and mitigate bugs or other issues before releasing and deploying the upgrades.

Blue/Green methods alternate two identical environments, exposing one half to the new version for evaluation prior to a full estate update. In blue-green deployments, two servers can be maintained: a “blue” server and a “green” server. One server at a time handles requests (e.g., being pointed to by the DNS). Public requests may be routed to the blue server, making it the production server and the green server the staging server, which can only be accessed on a private network. The new version (e.g., upgrade) is installed on the non-live server, which is then tested through the private network to verify the new version works as expected. Once verified, the non-live server is swapped with the live server, thereby deploying the new version.

Blue/Green methods enable quickly rolling back to a previous state if anything goes wrong. This rollback is achieved by routing traffic back to the previous live server, which still executes the original version (e.g., does not have the deployed changes). Blue/Green methods advantageously reduce downtime for the server and mitigate periods during which requests are unfulfilled.

Canary and rolling upgrade methods can use a graduated exposure across the estate, rolling back to the previous version if problems are detected. In firewalls, these methods can be extended through careful use of traffic mirroring and behavioral observation, where traffic intended for one firewall is mirrored to a second in a coordinated fashion, looking for expected and unexpected differences in behavior.

Continuous integration, continuous deployment (CI/CD) can be realized by validating an upgraded version of software or networking infrastructure using a traditional continuous integration (CI) system, and then the upgrade can be deployed using one or more of the above-noted CD methods. This allows the upgrade to be evaluated against the specific traffic/policy combination seen in a particular production environment or device.

Improved CI/CD methods are desired that are more effective for detecting/preempting problems that occur when an upgrade is deployed in the production environment.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a flow diagram of an example of a method for testing an upgrade to a network component, in accordance with certain embodiments.

FIG. 2 illustrates an example of a flow table, in accordance with certain embodiments.

FIG. 3 illustrates an example of 5-tuple rules, in accordance with one embodiment.

FIG. 4 illustrates a flow diagram for an example of a method of implementing a software development lifecycle (SDLC), in accordance with certain embodiments.

FIG. 5A illustrates a block diagram of a first example of a network, in accordance with certain embodiments.

FIG. 5B illustrates a block diagram of a second example of the network, in accordance with certain embodiments.

FIG. 6 illustrates a block diagram of an example of a network device, in accordance with certain embodiments.

FIG. 7 illustrates a block diagram of an example of a computing device, in accordance with some embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### OVERVIEW

In some aspects, the techniques described herein relate to a method of testing versions of a network components, the method including: obtaining a first flow table based on measured data flows, the first flow table having been generated using a first version of a network component; generating, for respective entries in the first flow table, corresponding entries in a second flow table representing a response of a second version of the network component to data packets sampled from the measured data flows to have characteristics of the corresponding entries; comparing the first flow table with the second flow table to generate comparison results; and evaluating whether the second version of the network component can be deployed based on the comparison results.

In some aspects, the techniques described herein relate to a method, wherein comparing the first flow table with the second flow table includes that each of the comparison results is a comparison result of a respective entry of the respective entries in the first flow table, and the comparison result is generated by comparing the respective entry with a corresponding entry in the second flow table.

In some aspects, the techniques described herein relate to a method, further including: capturing the measured data flows by collecting data flows from a production environment; obtaining a captured flow table that includes respective entries corresponding to types of data flows, wherein each of the types of data flows includes a range of source addresses and a range of destination addresses; generating the respective entries of the first flow table using simulated traffic for an entry in which data packets corresponding to a type of the entry is sampled from the measured data flows and generating first statistics and first metadata for the entry by applying the simulated traffic to the first version of a network component; and generating the corresponding entries in the second flow table by generating second statics and second metadata for the corresponding entries by applying the simulated traffic to the second version of a network component.

In some aspects, the techniques described herein relate to a method, wherein generating the corresponding entries in the second flow table further includes ensuring correctness of the corresponding entries using additional data collected from the network component, wherein the additional data includes DNS cache data mapping symbolic names to IP addresses.

In some aspects, the techniques described herein relate to a method, wherein the first flow table and the second flow table include entries for both allowed packets and denied packets.

In some aspects, the techniques described herein relate to a method, wherein each entry in the first flow table and the second flow table includes a field for a source, a destination, whether data packets were allowed or denied, metadata, and statistics.

In some aspects, the techniques described herein relate to a method, wherein the first flow table and the second flow table include entries for dropped packets, blocked packets, and/or restricted packets.

In some aspects, the techniques described herein relate to a method, wherein: the first flow table is for processing data flows at open systems interconnection (OSI) layer two (L2), and a source address field and a destination address field for each entry in the first flow table and in the second flow table are media access control (MAC) addresses, the first flow table is for processing data flows at OSI layer three (L3), and the source address field and destination address field are internet protocol (IP) addresses, and/or the first flow table is for processing data flows at OSI layer four (L4), the source address field and destination address field are MAC addresses and/or IP addresses, and the first flow table and the second flow table can include a field for a connection state.

In some aspects, the techniques described herein relate to a method, wherein comparing the first flow table with the second flow table includes: comparing whether decisions made for a flow-table entry are consistent between the first flow table and the second flow table, comparing processing resources used for the decisions between the first flow table and the second flow table, and/or comparing performance statistics between the first flow table and the second flow table.

In some aspects, the techniques described herein relate to a method, evaluating whether the second version of the network component can be deployed includes: preventing the second version of the network component from being deployed when the comparison results indicate a degradation in performance statistics of the second version of the network component relative to the first version of the network component, and/or preventing the second version of the network component from being deployed when one or more inconsistencies between an expected characteristic of egress packets from the second version of the network component relative to an actual characteristic of egress packets from the second version of the network component.

In some aspects, the techniques described herein relate to an apparatus including: a processor; and a memory storing instructions that, when executed by the processor, configure the apparatus to: obtain a first flow table based on measured data flows, the first flow table having been generated using a first version of a network component; generate, for respective entries in the first flow table, corresponding entries in a second flow table representing a response of a second version of the network component to data packets sampled from the measured data flows to have characteristics of the corresponding entries; compare the first flow table with the second flow table to generate comparison results; and evaluate whether the second version of the network component can be deployed based on the comparison results.

In some aspects, the techniques described herein relate to an apparatus, wherein configuring the apparatus to compare the first flow table with the second flow table includes that each of the comparison results is a comparison result of a respective entry of the respective entries in the first flow table, and the comparison result is generated by comparing the respective entry with a corresponding entry in the second flow table.

In some aspects, the techniques described herein relate to an apparatus, wherein the instructions further configure the apparatus to: capture the measured data flows by collecting data flows from a production environment; obtain a captured flow table that includes respective entries corresponding to types of data flows, wherein each of the types of data flows includes a range of source addresses and a range of destination addresses; generate the entries of the first flow table using simulated traffic for an entry in which data packets corresponding to a type of the entry is sampled from the measured data flows and generating first statistics and first metadata for the entry by applying the simulated traffic to the first version of a network component; and generate the corresponding entries in the second flow table by generating second statics and second metadata for the corresponding entry by applying the simulated traffic to the second version of a network component.

In some aspects, the techniques described herein relate to an apparatus, wherein the instructions configure the apparatus to generate the corresponding entries in the second flow table by configuring the apparatus to ensure correctness of the corresponding entries using additional data collected from the network component, wherein the additional data includes DNS cache data mapping symbolic names to IP addresses.

In some aspects, the techniques described herein relate to an apparatus, wherein the first flow table and the second flow table include entries for both allowed packets and denied packets.

In some aspects, the techniques described herein relate to an apparatus, wherein each entry in the first flow table and the second flow table includes a field for a source, a destination, whether data packets were allowed or denied, metadata, and statistics.

In some aspects, the techniques described herein relate to an apparatus, wherein the first flow table and the second flow table include entries for dropped packets, blocked packets, and/or restricted packets.

In some aspects, the techniques described herein relate to an apparatus, wherein: the first flow table is for processing data flows at open systems interconnection (OSI) layer two (L2), and a source address field and a destination address field for each entry in the first flow table and in the second flow table are media access control (MAC) addresses, the first flow table is for processing data flows at OSI layer three (L3), and the source address field and destination address field are internet protocol (IP) addresses, and/or the first flow table is for processing data flows at OSI layer four (L4), the source address field and destination address field are MAC addresses and/or IP addresses, and the first flow table and the second flow table can include a field for a connection state.

In some aspects, the techniques described herein relate to an apparatus, wherein the instructions configuring the apparatus to compare the first flow table with the second flow table further includes configuring the apparatus to: compare whether decisions made for a flow-table entry are consistent between the first flow table and the second flow table, compare processing resources used for the decisions between the first flow table and the second flow table, and/or compare performance statistics between the first flow table and the second flow table.

In some aspects, the techniques described herein relate to an apparatus, wherein the instructions configuring the apparatus to evaluate whether the second version of the network component can be deployed includes configuring the apparatus to: prevent the second version of the network component from being deployed when the comparison results indicate a degradation in performance statistics of the second version of the network component relative to the first version of the network component, and/or prevent the second version of the network component from being deployed when one or more inconsistencies between an expected characteristic of egress packets from the second version of the network component relative to an actual characteristic of egress packets from the second version of the network component.

In some aspects, the techniques described herein relate to a non-transitory computer-readable storage medium, the computer-readable storage medium including instructions that when executed by a computer, cause the computer to: obtain a first flow table based on measured data flows, the first flow table having been generated using a first version of a network component; generate, for respective entries in the first flow table, corresponding entries in a second flow table representing a response of a second version of the network component to data packets sampled from the measured data flows to have characteristics of the corresponding entries; compare the first flow table with the second flow table to generate comparison results; and evaluate whether the second version of the network component can be deployed based on the comparison results.

In some aspects, the techniques described herein relate to a non-transitory computer-readable storage medium, wherein configuring the apparatus to compare the first flow table with the second flow table includes that each of the comparison results is a comparison result of a respective entry of the respective entries in the first flow table, and the comparison result is generated by comparing the respective entry with a corresponding entry in the second flow table.

In some aspects, the techniques described herein relate to a non-transitory computer-readable storage medium, wherein the instructions cause the computer to: capture the measured data flows by collecting data flows from a production environment; obtain a captured flow table that includes respective entries corresponding to types of data flows, wherein each of the types of data flows includes a range of source addresses and a range of destination addresses; generate the entries of the first flow table using simulated traffic for an entry in which data packets corresponding to a type of the entry is sampled from the measured data flows and generating first statistics and first metadata for the entry by applying the simulated traffic to the first version of a network component; and generate the corresponding entries in the second flow table by generating second statics and second metadata for the corresponding entry by applying the simulated traffic to the second version of a network component.

In some aspects, the techniques described herein relate to a non-transitory computer-readable storage medium, wherein the instructions cause generating the corresponding entries in the second flow table by causing the computer to to ensure correctness of the corresponding entries using additional data collected from the network component, wherein the additional data includes DNS cache data mapping symbolic names to IP addresses.

In some aspects, the techniques described herein relate to a non-transitory computer-readable storage medium, wherein the first flow table and the second flow table include entries for both allowed packets and denied packets.

In some aspects, the techniques described herein relate to a non-transitory computer-readable storage medium, wherein each entry in the first flow table and the second flow table includes a field for a source, a destination, whether data packets were allowed or denied, metadata, and statistics.

In some aspects, the techniques described herein relate to a non-transitory computer-readable storage medium, wherein the first flow table and the second flow table include entries for dropped packets, blocked packets, and/or restricted packets.

In some aspects, the techniques described herein relate to a non-transitory computer-readable storage medium, wherein: the first flow table is for processing data flows at open systems interconnection (OSI) layer two (L2), and a source address field and a destination address field for each entry in the first flow table and in the second flow table are media access control (MAC) addresses, the first flow table is for processing data flows at OSI layer three (L3), and the source address field and destination address field are internet protocol (IP) addresses, and/or the first flow table is for processing data flows at OSI layer four (L4), the source address field and destination address field are MAC addresses and/or IP addresses, and the first flow table and the second flow table can include a field for a connection state.

In some aspects, the techniques described herein relate to a non-transitory computer-readable storage medium, wherein the instructions cause comparing the first flow table with the second flow table by causing the computer to: compare whether decisions made for a flow-table entry are consistent between the first flow table and the second flow table, compare processing resources used for the decisions between the first flow table and the second flow table, and/or compare performance statistics between the first flow table and the second flow table.

In some aspects, the techniques described herein relate to a non-transitory computer-readable storage medium, wherein the instructions cause evaluating whether the second version of the network component can be deployed by causing the computer to: prevent the second version of the network component from being deployed when the comparison results indicate a degradation in performance statistics of the second version of the network component relative to the first version of the network component, and/or prevent the second version of the network component from being deployed when one or more inconsistencies between an expected characteristic of egress packets from the second version of the network component relative to an actual characteristic of egress packets from the second version of the network component.

### EXAMPLE EMBODIMENTS

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for improvements in testing and validating software and/or policy upgrades to network components. For example, the systems and methods disclosed herein can improve testing for continuous integration, continuous deployment (CI/CD) by using a flow table to compare the performance of the current version of software and/or policies to the upgraded version and evaluate whether to upgrade satisfies the criteria for deployment. The systems and methods disclosed herein can use acquired data flows and/or flow tables from a production environment to provide testing in a testing environment before the upgrade is deployed.

Using acquired data flows and/or flow tables from a production environment to guide tests performed on the upgrade in the testing environment fills a gap in traditional CI/CD approaches where the validation tests performed on the upgrade in the testing environment are not necessarily representative of the production environment. For example, in traditional CI/CD approaches, a new version of software and/or policies for a network component (hereafter abbreviated as “new version of a network component”) can be validated against a standardized test suite, but the production environment can have a different skew of traffic, such that the new version of the network component can encounter unexpected problems when deployed in the production environment. By using testing and validation that is more representative of the production environment, it is possible to reduce the number of unexpected problems encountered upon deployment of the new version of a network component in the production environment.

According to certain non-limiting examples, the systems and methods disclosed herein generate simulated traffic based on the traffic distributions of acquired data acquired from a production environment (e.g., a customer's own data). One or more flow tables based on acquired data can be used to run simulations of the production environment. The entries in the flow table can be defined/indexed by source-destination pairs or 5-tuples. A data flow is a sequence of data packets that have common attributes (e.g., have the same 5-tuple of (1) source IP address, (2) destination IP address, (3) IP protocol, (4) source port, and (5) destination port). Once any of the attributes change, a new flow begins. The type of the data flow is defined by the common attributes, and each entry in the flow table corresponds to a respective type of the data flow. For open systems interconnection (OSI) layer two (L2), the common attributes can be the source and destination media access control address (MAC) addresses. For OSI layer three (L3), the common attributes can be the 5-tuple or the source and destination internet protocol (IP) addresses. For OSI layer four (L4), the common attributes can also include the connection state (e.g., whether the state is a TCP connection in an established state or if the state is still ramping up).

According to certain non-limiting examples, the simulated traffic can be representative of the statistical profile of the acquired data in various ways. For example, the length of these data flows (i.e., the number of data packets in a given data flow) can have the same statistical distribution as the acquired data. The statistical profile of the lengths of the data flows can be different for different types of data flows (i.e., for different entries in the flow table). Further, the statistical distribution of the size of data packets can be selected to be representative of the acquired data.

According to certain non-limiting examples, the acquired data can be obtained from different within a network, resulting in different flow tables and statistics corresponding to the different points. The new version of the network component can be tested against these different flow tables and different statistical profiles.

Simulated data can be generated based on the acquired data and based on the acquired flow tables. The simulated data can be applied both to a new version of the network component and the current version of the network component. A first flow table can be generated by applying the simulated data to the current version of the network component and monitoring the performance of the current version of the network component. Similarly, a second flow table can be generated by applying the simulated data to the new version of the network component and monitoring the performance of the new version of the network component.

According to certain non-limiting examples, an entry in the flow table for a given type of data flow includes various fields representing different aspects that are accumulated for all instances of the given type of data flow. One or more fields represent header information (e.g., the 5-tuple or source-destination pair).

One or more fields can be used to record metadata accumulated for the instances of the given type of data flow. For example, the metadata can include the time of the last entry, which rule/policy was matched for the given type of data flow, and other information related to supporting the operation of the network component, the data flows. Additionally or alternatively, the metadata can include a pointer to the version of the policy that was evoked. Additionally or alternatively, the metadata can include both the rule and the policy that was evoked to either allow or deny the flow. According to certain non-limiting examples, the flow table can include anti-flow information (e.g., information about data flows denied) in addition to the flow information for the data flows that were allowed.

One or more fields can be used to record statistics accumulated for the instances of the given type of data flow. For example, the statistics can include counts of how many packets were received in respective data flows and how many packets were sent by the network component. Additionally or alternatively, the statistics can include how many packets were dropped for the data flows. Additionally or alternatively, the statistics can include the packet latency at the network component, the mean packet size in the data flows, the minimum packet size, and the maximum packet size.

According to certain non-limiting examples, the data flows for the current and new versions of the network component can be compared and evaluated to determine when the new version of the network component is operating as desired with respect to function (e.g., does the network component make the correct decision regarding which flows to allow and which to deny) and performance (e.g., does the network component make decisions without using excessive amounts of processing resources or causing excessive packet latency).

According to certain non-limiting examples, different sets of simulated data can be generated for different statistical profiles. For example, the acquired data from the production environment can be collected from different points within the network, and these different points can present different statistical profiles for the data flows sampled therefrom.

For example, a network component can include a firewall policy with five rules. At a first point in the network, the acquired data mostly exercise only the first two rules, and there are only a handful of data flows that exercise the last three rules. As a concrete example, the acquired data can include 1500 data flows, with 1000 flows exercising the first rule and 494 flows exercising the second rule. The last three rules are reach exercised by two of the remaining six flows. One set of simulated data could be generated by selecting flows at random to match this statistical profile. The simulation can continue until the sample size for each entry in the flow table is statistically significant according to a predefined confidence level.

At a second point in the network, the acquired data might have a different statistical profile. For example, the statistical profile at the second point could be representative of the exhaustion of resources attack in which many of the data flows correspond to anti-flow entries in the flow table. Further, the fifth rule of the five rules discussed above can be a rule that defends against exhaustion of resources attacks (e.g., a deny-all rule), which under typical data flows is infrequently exercised. As a concrete example, the acquired data at the second point in the network can include 12,000 data flows with 1500 data flows exercising the first rule, 496 data flows exercising the second rule, two data flows exercising each of the third and fourth rules, and 10,000 data flows exercising the fifth rule. In addition to testing the new version of the network component against simulated data having a statistical profile corresponding to the first point (e.g., normal operation conditions), it can also be advantageous to test the new version of the network component against simulated data having a statistical profile corresponding to the second point to ensure that the new version of the network component does not fail under anomalous but foreseeable conditions.

According to certain non-limiting examples, the simulated data can have various characteristics or statistical properties observed in the acquired data to test how the new version of the network component performs under conditions that are reasonable likely to occur in a production environment. For example, one part of the functions performed by the new version of the network component can be the initial match of the header information of the packets to the rule (e.g., does the 5-tuple of the rule match the 5-tuple of the header). There are two aspects in which the initial match can be tested: (1) function-did the matching algorithm get the correct result and (2) performance-how much processing resources were required to determine the initial match? When the acquired data includes data flows with lengths of 10,000 packets, the simulated data flows can also include data flows with lengths of 10,000 packets. The statistics generated and recorded in the flow tables when applying the data flows with lengths of 10,000 packets can be used in the comparison and evolution steps to check that the new version of the network component is not running up the CPU or memory usage more than is desirable.

According to certain non-limiting examples, the acquired data flows can be used to generate flow tables in which respective entries in the flow table correspond to respective pairs of source and destination addresses. The entries in a first flow table can include statistics and metadata fields generated by applying the acquired data flows to the current version, and the entries in a second flow table can include statistics and metadata fields generated by applying the acquired data flows to the upgraded version. Then the first and second flow tables can be compared and the comparison result be evaluated to determine whether the upgraded version satisfies predefined deployment verification criteria.

According to certain non-limiting examples, the first and second flow tables can be used for validation of the new versions of network components. The new versions can be new policies implemented by the network component or new software (e.g., instructions that are executed in the data plane, control plane, and/or management plane of a network component/device).

According to certain non-limiting examples, the systems and methods disclosed herein can be used to verify that a new version has the same behavior as the previous version within certain bounds, or that differences between the functioning of the new version and the previous version are expected and desired. Thus, the systems and methods disclosed herein can be used to ensure that a software/policy update does not break or change the desired behavior either performance or functionally.

According to certain non-limiting examples, different types of data flows in a data flow can evoke/trigger different network policies, different rules in a firewall, or different portions of the software executed in a network component (e.g., different branches from conditional statements). For example, a 5-tuple rule in a firewall can be triggered when the source, destination, and protocol of a data packet matches the source, destination, and protocol of the 5-tuple rule. The statistical distribution of data packets can result in disproportionately triggering some rules much more frequently than other rules. When a flow table is not used, less frequently triggered rules can be underrepresented in a comparison and analysis of the new version relative to the current version. The systems and methods disclosed herein can ensure that rules and/or policies that are infrequently exercised when applying the acquired data are adequately tested (e.g., a testing include a sufficiently large enough sample size of data flows exercising the rule) to provide a predetermined confidence that the new version of the network component is operating as desired.

According to certain non-limiting examples, the network component can include a control plane that controls a dataplane in which data packets are received at various ingress ports, processed in some manner (e.g., filtered, routed, forwarded, processed through a firewall, etc.), and then transmitted from the various egress ports of the network component.

According to certain non-limiting examples, the systems and methods disclosed herein can achieve CI/CD for infrastructure, edge-computing components (e.g., hardware and software), and embedded edge devices, such that problems can be discovered and mitigated prior to deployment in a production environment.

Examples of network components can include, but are not limited to, software-defined wide area network (SD-WAN) appliances, firewalls, load balancers, routers, switches, data processing units (DPUs), virtual machines that are implemented on one or more processors (e.g., a central processing unit (CPU)) for performing network functions or implementing network policies, or another component or device implemented at a network edge.

According to certain non-limiting examples, the network edge device can include the following three planes: (i) the dataplane, which processes the transit traffic; (ii) the control plane, which sends and receives control signals to monitor and control the transit traffic; and (iii) the management plane, which interacts with the user or the network management system (NMS).

Consider, For example, the operation of a router as an illustrative network edge device. Interfaces, IP subnets, and routing protocols can be configured through management plane protocols, including, e.g., a command-line interface (CLI), Network Configuration Protocol (NETCONF), and a northbound Representational State Transfer (REST) Application Programming Interface (API). The router runs control plane routing protocols (e.g., Open Shortest Path First (OSPF), Enhanced Interior Gateway Routing Protocol (EIGRP), Border Gateway Protocol (BGP), etc.) to discover adjacent devices and the overall network topology, or to discover reachability information in case of distance/path vector protocols). The router inserts the results of the control-plane protocols into Routing Information Base (RIB) and Forwarding Information Base (FIB). The dataplane software or ASICs, e.g., then use the FIB structures to forward the transit traffic. The management plane protocols (e.g., Simple Network Management Protocol (SNMP)) can then be used to monitor the device operation, its performance, interface counters, etc.

Continuing with the non-limiting example of the network edge device being a router, in addition to controlling the routing protocols, the control plane protocols can also perform numerous other functions including: (i) interface state management (e.g., Point-to-Point Protocol (PPP), Transmission Control Protocol (TCP), and Link Aggregation Control Protocol (LACP)); (ii) connectivity management (e.g., Bidirectional Forwarding Detection (BFD), Connectivity Fault Management (CFM), etc.); (iii) adjacent device discovery (e.g., “hello” mechanisms present in most routing protocols, such as, End System-to-Intermediate System (ES-IS), Address Resolution Protocol (ARP), Internet Protocol version 6 (IPv6_Neighbor Discovery Protocol (NDP), Universal Plug and Play (UPnP) Simple Service Discovery Protocol (SSDP), etc.); (iv) topology or reachability information exchange (IP/IPv6 routing protocols, Intermediate System to Intermediate System (IS-IS) in Transparent Interconnection of Lots of Links (TRILL) and Shortest Path Bridging (SPB), Spanning Tree Protocol (STP), etc.); and (v) service provisioning (e.g., Resource Reservation Protocol (RSVP) for IntServ or Traffic Engineering (TE) based on Multiprotocol Label Switching (MPLS), uPNP SOAP (Simple Object Access Protocol) calls, etc.).

Still continuing with the non-limiting example of the network edge device being a router, in addition to forwarding packets, the dataplane can also perform the following functions: (i) network address translation (NAT) session creation and NAT table maintenance; (ii) neighbor address gleaning (e.g., dynamic Media Access Control (MAC) address learning in bridging, IPv6 Source Address Validation Improvement (SAVI), etc.); (iii) NetFlow or sampled flow (sFlow) accounting; (iv) network access control list (ACL) logging; and (v) Error signaling, such as Internet Control Message Protocol (ICMP).

According to certain non-limiting examples, the management and control planes can be implemented in a central processing unit (CPU) or in a data processing unit (DPU). According to certain non-limiting examples, the data plane could be implemented in numerous ways, including, e.g.: (i) as optimized code running on the same CPU as the control plane; (ii) as code running on a dedicated CPU core (e.g., a dedicated CPU for high-speed packet switching, such as a Linux server); (iii) as code running on linecard CPUs (e.g., a CISCO 7200 series router); (iv) as dedicated processors (e.g., network processing units (NPUs), data process units (DPUs), smart network interface cards (SmartNICs), etc.); and (v) as switching hardware (application-specific integrated circuits (ASICs), field programmable gate arrays (FPGAs), etc.); and (vi) as switching hardware on numerous linecards.

According to certain non-limiting examples, the dataplane receives and processes the ingress packets. Further, the dataplane can selectively forward packets destined for the router (e.g., Secure Shell (SSH) traffic or routing protocol updates) or packets that need special processing (e.g., IP datagrams with IP options or IP datagrams that have exceeded their TTL) to the control plane.

According to certain non-limiting examples, the management ports on some devices (e.g. data center switches) can be connected directly to a control-plane CPU and thus bypass a switching ASIC.

According to certain non-limiting examples, the control plane can pass outbound packets to the dataplane, or use its own forwarding mechanisms to determine the outgoing interface and the next-hop router (e.g., when using the local policy routing).

Different data packets can evoke/trigger different rules in a firewall/policy or different portions (e.g., conditional statements) of the software executed in a network component. For example, a 5-tuple rule in a firewall can be triggered when the source, destination, and protocol of a data packet matches the source, destination, and protocol of the 5-tuple rule. The statistical distribution of data packets can result in disproportionately triggering a subset of all the rules or scenarios being tested during the validation of an upgrade (e.g., policy or software) to the network component. This can result in little weight being given to the underrepresented rules/scenarios during validation.

Using flow tables for validation can avoid less frequently rules/scenarios being underrepresented during validation because each entry in the flow table can correspond to a different rule or scenario (or at least a subset of the rules or scenarios). By comparing each entry of the flow table for changes arising from the upgrade, the less frequently rules/scenarios are not overwhelmed by the for frequently rules/scenarios.

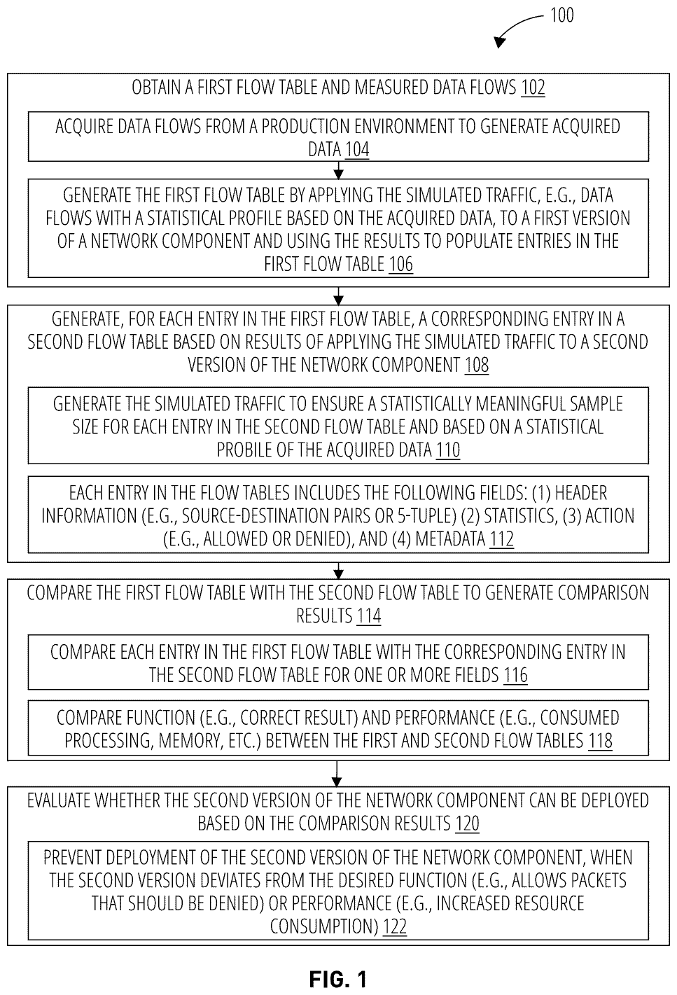

FIG. 1 illustrates an example method 100 for using flow tables to test and validate a new version of a network component. Although the example method 100 depicts a particular sequence of operations, the sequence may be altered without departing from the scope of the present disclosure. For example, some of the operations depicted may be performed in parallel or in a different sequence that does not materially affect the function of the method 100. In other examples, different components of an example device or system that implements the method 100 may perform functions at substantially the same time or in a specific sequence.

For example, the systems and methods disclosed herein can use flow tables to analyze and compare the performance of the new version of the network component to a current version of the network component. The new version can be new policies implemented by the network component or new software (e.g., in the data plane, control plane, or management plane) that is executed by the network component. Using a flow table has the benefit that each type of data packet in a measured data flow is sufficiently represented during testing and validation to fully inform the decision whether to promote the new version to the next phase of testing.

For example, different entries in the flow table can correspond to different rules in a firewall or different policies implemented by a router. A measured data flow can be used for testing, but the frequency of data packets corresponding to the first entry in the flow table may be much greater than the frequency of data packets corresponding to the second entry, resulting in the measured data flow providing a sufficient sample size to draw conclusions for how the new version processes the type of data flows represented in the first entry while providing an insufficient sample size to draw conclusions for how the new version processes the type of data flows represented in the second entry.

Additionally, even if the data flow provides a sufficient sample size for all entries in the flow table, if the results for all data packets are considered together and/or averaged, the combined performance results might be within a statistically allowable range for the desired performance values, whereas considered separately the performance results can be used to correctly identify a problem with how the new version processes one of the less frequent types of data flows. That is, when a combined result is considered the more frequent types of data flows might overwhelm the less frequent types of data flows, such that measurable deviations due to the less frequent types of data flows are obscured.

The systems and methods disclosed herein can mitigate the above-noted challenges by testing the new version using a flow table. When the results of processing the data flow are organized according to a flow table and the entries in the flow table are considered separately, then the deviations due to one type of data packet will not be obscured or masked by another type of data packet because each type of data packet can correspond to a different entry in the flow table. Further, according to certain non-limiting examples, the testing data flow can be sampled from the measured data flow to ensure that a sufficient sample size is provided for each type of data packet. Depending on whether the network component is stateless or stateful (e.g., whether the network component has memory causing the processing the current data packet to depend on one or more previously processed data packets), the sampled data flow can be tailored to provide results consistent with the measured data flow.

According to some examples, in process 102, the method includes obtaining a first flow table and obtaining measured data flows. Process 102 can include step 104 and step 106.

In step 104, the method includes acquiring/capturing the measured data flows by collecting data flows from a production environment.

For example, measured data flows can be collected from multiple instances of a network component that is operating at different points within the network. According to certain non-limiting examples, the measured data flows are acquired from a production environment in which a customer is using the version of the network component to process their own traffic. Thus, the data flows can be representative of actual traffic, thereby avoiding a scenario where the new version of the network component passes validation testing on artificial data and then fails when deployed using the customer's acquired data.

According to certain non-limiting examples, different points within the network can encounter a different profile or distribution of types of data flows. Different types of data flows can invoke different rules. For example, a 5-tuple rule can indicate actions taken based on the source address of the data packet, the source port of the data packet, the destination address of the data packet, the destination port of the data packet, and/or the protocol of the data packet (e.g., transmission control protocol (TCP) or user datagram protocol (UDP)). For example, a 5-tuple rule can take the format {action, src_address, src_port, dest_address, dest_port, protocol}, such that the 5-tuple rule {allow, 0.2.1.0/24, *, 8.8.8.88/24, 53, *} would allow packets having a source address within the/24 address range “0.2.1.0/24” that are going to destination address within the/24 address range “8.8.8.88/24” and having destination port “53” independent of the data packets protocol and source port. Thus, when the network component is a firewall having 5-tuple rules, the types of data packets can correspond to the sets of characteristics that invoke certain 5-tuple rules. The 5-tuple rules can be applied in the order they are defined in the firewall, such that a data packet that matches the pattern of more than one rule will apply the action for the first match.

For a given data flow, there can be more data packets that trigger the rules at the top of the list of rules and fewer data packets that trigger the rules at the bottom. Further, there can be rules to protect against certain types of cyber attacks, and these rules might not be exercised, unless the data flows were acquired during that certain type of cyber attack. For example, one of the rules might drop packets that match a pattern indicative of a denial of services attack. Depending on whether the measured data flows include the pattern indicative of the denial of services attack, this rule might either be exercised a lot or a little. Acquiring data flows from different nodes in the network can provide greater diversity for the types of data flows represented in the measured data flows.

In step 106, the method includes generating the first flow table by applying the measured data flows (or sampled data packets thereof) to a first version of a network component and populating entries in the first flow table based on the response of the first version to the measured data flows.

For example, the data flow can be captured from network components executing a first version of the network component (e.g., the first version can be a current version and the second version can be an upgrade). The first flow table can be generated from observations of the first version of the network component as the measured data flows are being captured. Additionally or alternatively, the first flow table can be populated by running a simulated data flow generated from the measured data flow. Preferably, the first flow table is generated using a same data flow as the second flow table. Accordingly, when the simulated data flow is sampled from the measured data flow, this same simulated data flow can be used to also generate the first flow table.

According to some examples, in process 108, the method includes generating, for each entry in the first flow table, a corresponding entry in a second flow table based on responses of a second version of the network component to data packets sampled from the measured data flows at process 108. Process 108 can include step 110 and option 112. Step 110 and option 112 are illustrative of certain non-limiting examples, and process 108 can be performed using different steps. For example, the second flow table can be generated using all the measured flow data, rather than sampling parts of the measured flow data.

In step 110, for each entry in the first flow table, a predefined number of data packets are sampled that match the entry (e.g., are the type of data flows matching a rule corresponding to the entry) to provide a simulated data flow. The simulated data flow is applied to the second version of the network component to generate observations that are used to populate that entry. The predefined number of data packets is selected to ensure that a statistically meaningful sample size is used to populate the entry in the second flow table.

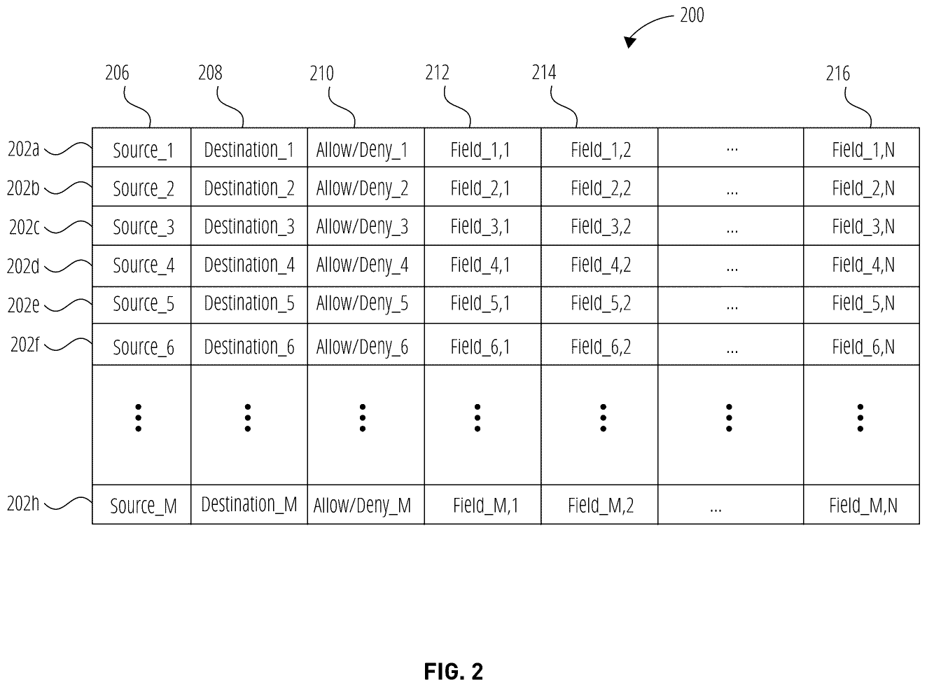

In option 112, the method includes each entry in the flow tables includes the following fields: (1) source, (2) destination, (3) allowed or denied, (4) metadata, and (5) statistics. FIG. 2 illustrates a non-limiting example of a flow table, and the field of the flow table are discussed below with reference to FIG. 2.

The statistics for each entry can include, e.g., the mean time for a given version of the network component to process the packets captured under that entry (e.g., packets having a source-destination pair matching that entry), and, according to certain non-limiting examples, the statistics can include other statistical moments in addition to the mean (e.g., variance, skewness, kurtosis, etc.).

According to some examples, in process 114, the method includes comparing the first flow table with the second flow table to generate comparison results. Process 114 can include step 116 and step 118. Step 116 and step 118 are illustrative of certain non-limiting examples, and process 114 can be performed using different steps.

In step 116, the method includes comparing each entry in the first flow table with the corresponding entry in the second flow table for one or more fields.

In step 118, the method includes comparing performance statistics and/or consumed resources (e.g., processing, memory, etc.) between the flow tables.

According to some examples, in process 120, the method includes evaluating whether the second version of the network component can be deployed based on the comparison results. Process 120 can include step 122.

In step 122, the method includes preventing deployment of the second version of the network component, when the second version causes a degradation in performance (e.g., increased resource consumption) and/or unexpected characteristics for the egress packets.

According to certain non-limiting examples, process 120 can evaluate whether the second version of the network component can be deployed based on

According to certain non-limiting examples, process 120 can evaluate whether the second version of the network component can be deployed based on whether the second version passed or failed the verification test(s).

According to certain non-limiting examples, method 100 can be performed in accordance with the pseudocode:

Simflowtable = { }
for each entry ((S, D), { allow,deny}, metadata, stats) in the flow table F
Simflowtable.insert( evaluate policy(S, D) −> ( { allow, deny }, M′, S′) )
DIFF = F − Simflowtable,

wherein “F” is an acquired flow table representing the acquired data, “(S,D)” represents the header information identifying the entries in the flow table F, “{allow, deny}” is the information indicating whether the identified flow was allowed or denied, “metadata” is the field representing the metadata for the identified flows in flow table F, and “stats” is the field representing the statistics for the identified flows in flow table F. In the above pseudo-code, “Simflowtable” is a simulated flow table for the network component. The same algorithm works for both versions of the network component. First the Simflowtable object/data structure is initialized as being empty. Then for each entry flow table F, the loop in the pseudo-code inserts simulated results for the fields “{allow, deny}”, “M”, and “S”. In the simulated results, the field {allow, deny} represents whether the simulated data flows were allowed or denied by the policy being called by the “evaluate policy” function call, and the fields M′, and S′ represent the metadata and statistics generated by the “evaluate policy” function call. The “evaluate policy” function call uses the “(S,D)” header information identifying the data flow entry to generate simulated data and apply that simulated data to the software and/or policy being tested to generate the simulation results. Upon completion of the loop for each entry in flow table F, a comparison result “DIFF” is generated by applying a difference function (−), which is defined for flow table objects/data structures.

According to certain non-limiting examples, the second version can pass the verification test based on an accumulated confidence score over one or more simulations using simulated traffic of data flows based on the acquired data and the acquired flow table. For example, a confidence score can increase as simulated traffic is processed through the first and second versions of the network component and the comparison between statistics and metadata of the flow tables of the respective versions satisfy predefined verification criteria. As the quantity of simulated data processed for each type of data flow in the flow table and the comparison between the flow tables for the first and second versions continue to satisfy the verification criteria, the confidence increases that the new version is behaving in an acceptable/desirable manner. When the confidence score exceeds a predefined threshold over a predefined testing period, then the new version is determined to have passed the verification test.

According to certain non-limiting examples, after the predefined quantity of testing, a confidence score that is below the predefined threshold indicates failure, and the second version of the network component is not deployed. Rather corrective action is taken to modify the second version before subsequent verification testing.

Alternatively, a failed verification test can occur when the confidence score is less than a failure threshold, a passed verification test occurs when the confidence score exceeds a pass threshold, and a confidence score between the failure threshold and pass threshold is inclusive, resulting in generating additional simulated data and verification testing to obtain a conclusive pass or fail result.

According to certain non-limiting examples, after the testing the second version of the network component on a predefined quantality of simulated traffic, the results can be inconclusive and the quantality of simulated traffic can be increased to obtain a conclusive result, after applying the additional simulated traffic either the confidence score exceeds the pass threshold and the new version passes or the new version fails.

According to certain non-limiting examples, the confidence space can be multi-dimensional, such that multiple confidence scores can be generated with respect to different dimensions of the space. For example one dimension can relate to CPU usage, another dimension can relate to packet latency through the network component6. A third dimension can relate to memory usage, and so forth.

According to certain non-limiting examples, verification (e.g., evaluating whether the second version of the network component can be deployed based on the comparison result of the second version to the first version of the network component) can be predicated on assessing the difference in behaviors of two versions of network software and/or network policies. In many cases, a comparison between the two versions is more involved than merely observing that the performance of the new version matches the performance of the current version. For example, the new version can be expected to perform differently than the current version. For example, the new version might be intended to improve performance in certain aspects relative to the current version. Thus, the comparison between the performances of the two versions can be informed regarding expected differences in performance due to improvements integrated into the new versions, and, in anticipation of these differences, the comparison can set out criteria for the verification testing that account for the expected differences in performance.

In one case that exemplifies a simple verification, the new version of the software is a minor revision to the current software that is limited to optimizing the pipeline to improve performance. In this case, verification can be straightforward because the expected result of the new version of the software is that the same number of packets are received and transmitted, the same policies are matched, the CPU and memory usage are the same or lower, the latency of packets transiting the dataplane is reduced and the effective throughput increased. Thus, basic heuristics can be used to determine whether the new version is an improvement relative to the current version, which would signify a successful verification.

In other cases, however, verification is not as simple as in the above example. In such cases, new versions of software and policy can be accompanied by metadata that can inform the system how to interpret the results of the comparison between performances of the current and new versions to establish predefined criteria for verification.

In these more complicated/non-trivial verification cases, verification criteria can be established for various aspects of the performance comparison. For example, to determine that the new version of the software will not disrupt the network, various factors can be considered for the metrication of the performance when executing a firewall dataplane, including, e.g., CPU performance, memory usage, packet latency, and traffic volume. For example, the predefined verification criteria can include metrics related to changes in the CPU usage, including, e.g., the minimum CPU usage, the maximum CPU usage, and the average CPU usage. Further, the predefined verification criteria can include metrics related to o changes in memory usage, including, e.g., the minimum memory usage, the maximum memory usage, the average memory usage, and memory growth over the verification period. Additionally, the predefined verification criteria can include metrics related to changes in the packet latency, including, e.g., the average time it takes packets to traverse the dataplane.

In addition to the above performance metrics, the predefined verification criteria can include various traffic-volume metrics. These traffic-volume metrics can include, e.g., the total number of packets processed, the number of dropped packets, and the number of packets transmitted (i.e., transmitted from the ports to other network devices). In certain verification cases, it is anticipated that traffic volume should be identical at egress, between the primary and shadow dataplanes. For example, if N packets arrived and K packets were dropped due to policy, L packets should be transmitted at the end. For verification to be precise, the exact same number of packets (e.g., N packets) can be ensured on both dataplanes. The exact same number of packets can be ensured, e.g., by sending an inline control packet that signals the start and end of verification. This ensures that both dataplanes are operating on the same N.

Whereas traffic volume should be identical at egress for cases in which the policies or other aspects of the processing do not change the number of dropped packets, in other cases the number of dropped packets can change, but often the number of dropped packets will change in predictable ways, which can be communicated via the accompanying metadata to generate traffic-volume metrics that are indicative of the predicted changes. That is, some versions of software may alter the number of dropped packets (e.g., above K value) for valid reasons.

For instance, in the case that the current version of the software does not properly enforce dropping packets with a specific Internet Control Message Protocol (ICMP) code, but the new version does properly enforce dropping packets with the specific ICMP code. In this case, the new version can be expected to drop more packets than the current version.

According to certain non-limiting examples, the method can prevent the second version of the network component from being deployed when the comparison results indicate a degradation in performance statistics of the second version of the network component relative to the first version of the network component. Additionally or alternatively, the method can prevent the second version of the network component from being deployed when one or more inconsistencies between an expected characteristic of egress packets from the second version of the network component relative to an actual characteristic of egress packets from the second version of the network component.

For example, consider a network component that implements a firewall policy consisting of five rules. In this scenario, a typical data set may mostly include data flows that exercise the top two rules, with only a few data flows in the data set exercising/evoking the bottom three rules are used rarely. For concreteness, consider of statistical distribution of 1500 data flows in which 1000, 494, 2, 2, and2 data flows exercise/evoke the first, second, third, fourth, and fifth rules, respectively. Then to be representative of this typical data set, simulated traffic can be generated and applied to the new and current version of the firewall policy to generate respective flow tables. The simulated traffic can include, e.g., 1000 instances of data flows in which the data packets exercise/evoke the first rule. When the simulated data set is applied to the network component implementing this firewall policy, these 1000 data flows generate the statistics and metadata that are recorded in a first entry in the flow tables. Similarly, the simulated traffic can include, e.g., 494 instances of data flows that exercise/evoke the second rule, and, when applied to the two versions of the network component, these 494 instances generate the statistics and metadata that are recorded in a second entry in the respective flow tables. The simulated traffic can further include two data flows that exercise/evoke the third rule, two data flows that exercise/evoke the fourth rule, and two data flows that exercise/evoke the fifth rule.

The statistics for each entry can include, e.g., the mean time for a given version of the network component to process the packets captured under that entry (e.g., packets having a source-destination pair matching that entry), and, according to certain non-limiting examples, the statistics can include other statistical moments in addition to the mean (e.g., variance, skewness, kurtosis, etc.).

FIG. 2 illustrates flow table 200, which includes respective entries (e.g., entry 202a, entry 202b, entry 202c, entry 202d, entry 202c, entry 202f, and entry 202h). Each entry can include various fields including, e.g., a source address 206, a destination address 208, a field indicating whether the data packets were allowed or denied (i.e., allow/deny 210), and various other fields (e.g., field 212, field 214, and field 216).

A flow table is a data structure that summarizes the packet streams (flows) seen at network component, and the flow table associates data with each flow in the table. Each entry in the flow table represents a different type of data flows, as discussed above. For example, an entry can include the type of data flows that trigger a particular policy, a particular, 5-tuple rule, a particular Linux security module (LSM) hook, or a particular conditional statement or feature in the software running on the network component. An entry in the flow table records statistics for that type of data flows. For example, one of the fields can include a count that represents how many data packets have been recorded for that type of data flows. Other fields in the flow table can represent one or more statistical characteristics of the type of data flows and one or more metadata values of the type of data flows. When a data packet is encountered that matches the type of data flows for an entry, the entry is updated accordingly. For example, the count field is incremented and the fields corresponding to the one or more statistical characteristics of the type of data flows and one or more metadata.

As discussed above, the respective entries can be defined (at least partly) by the source address 206 and destination address 208. Often flow tables include only allowed data packets. Additionally or alternatively, flow table 200 can include entries for denied data packets. For example, the action for some 5-tuple rules can be to allow data packets to pass through the network component, and the action for other 5-tuple rules can be to deny data packets from passing through the network component. By capturing the activity of the network component for both allowed and denied actions, flow table 200 can be used to provide a more complement assessment of the network component and how the first version compares to the second version of the network component. For example, the network component can include rules/policies directed to defending a denial of service attack by denying/dropping data packets of the types defined in the rules/policies. Including “anti-flow” entries in which the denied statistics and metadata are recorded for the denied packets can be used to compare how the first and second versions of the network component function for the denied packets. For example, if the second version of the network component took five times more computation time per denied data packet, that information might be important when deciding whether to replace the first version of the network component with the second version of the network component.

The specific nature of the data recorded in the flow table can depend on the nature of the device and enabled functions. A flow is identified by a (source, destination) address pair. The network component can process the data flows at OSI layer two (L2), layer three (L3), layer four (L4), and/or layer seven (L7).

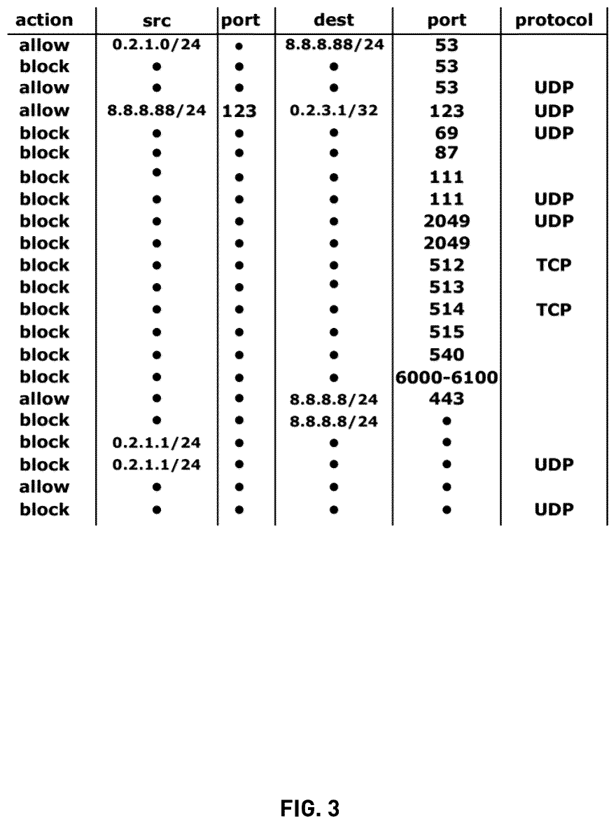

FIG. 3 shows an example of security policies defined using 5-tuples. A 5-tuple refers to a set of five different values that comprise a Transmission Control Protocol/Internet Protocol (TCP/IP) connection. It includes a source IP address/port number, destination IP address/port number, and the protocol in use. System and network administrators can use 5-tuples to identify key requirements for creating a secure, operational, and bidirectional network connection between two or more remote and local machines. The source address is the IP address of the network that creates and sends a data packet, and the destination address is the recipient.

For example, packets matching the 5-tuple in the first rule (i.e., a source address of “0.2.1.0/24”, a destination address of “8.8.8.88/24”, and a destination port of “53”) are allowed. Further, packets matching the 5-tuple in the second rule (i.e., a destination port of “53”) are denied. The rules can be applied in the order, such that when the criteria for an earlier rule are satisfied, subsequent rules are not invoked.

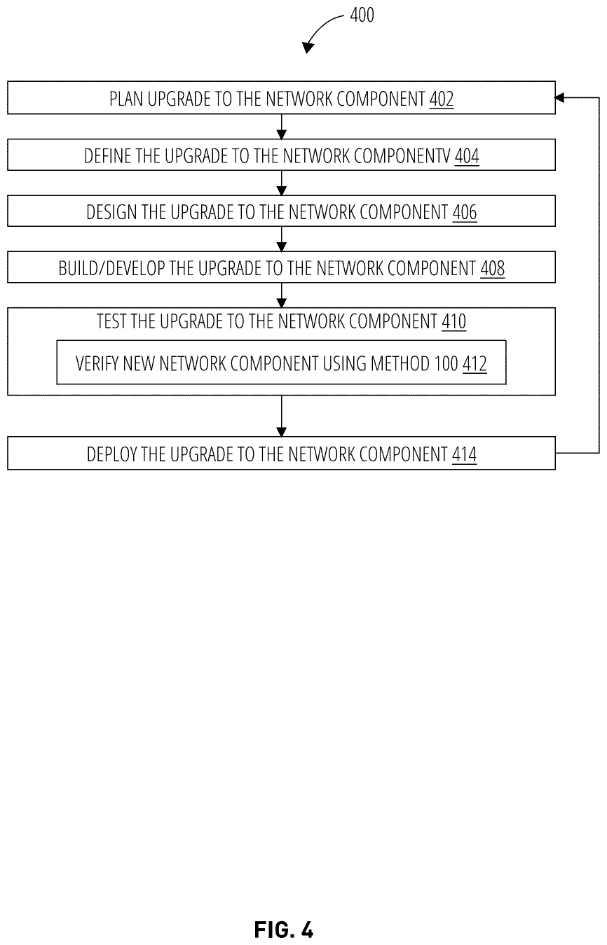

FIG. 4 illustrates an example of method 400 for a software development life cycle (SDLC). Although the example method 400 depicts a particular sequence of operations, the sequence may be altered without departing from the scope of the present disclosure. For example, some of the operations depicted may be performed in parallel or in a different sequence that does not materially affect the function of method 400. In other examples, different components of an example device or system that implements method 400 may perform functions at substantially the same time or in a specific sequence.

Method 400 provides a structured process to enable high-quality, low-cost network component development in a short period. Method 400 can produce an upgrade to the network component that meets customer expectations with minimal interruption. The term “component” as used herein refers to one or more devices, dataplane firmware or software, the control plane firmware or software, or the policy interpreted by the data and control planes, or a combination thereof. For example, a network component can include the circuitry and/or hardware and can include the instructions (e.g., firmware or software) implemented thereon. Further, the term “component” refers functionally to a discrete unit that can be individually updated, whether implemented on a single device or distributed across multiple devices, planes (e.g., data plane, control plane), or executable instructions (e.g., policies, firmware, or software)

identifies any discrete unit that can be individually updated: dataplane firmware or software, the control plane firmware or software, or the policy interpreted by the data and control planes

According to some examples, in step 402, the method includes planning an upgrade to the network component.

According to certain non-limiting examples, step 402 includes planning and requirement analysis. Requirement analysis can be performed by the senior members of the team with inputs from the customer, the sales department, market surveys, and domain experts in the industry.

This information can be used to plan the basic project approach based on studies in the economical, operational, and technical areas.

According to some examples, in step 404, the method includes defining the upgrade to the network component4.

According to certain non-limiting examples, upon completion of the requirement analysis, the product requirements can be defined and documented. Further, these product requirements can be approved by the customer or the market analysts. This can be done using a software requirement specification (SRS) document which consists of all the product requirements to be designed and developed during the project life cycle.

According to some examples, in step 406, the method includes designing the upgrade to the network component.

According to certain non-limiting examples, the SRS is used as the reference for product architects to come out with the best architecture for the product to be developed. Based on the requirements specified in SRS. According to certain non-limiting examples, more than one design approach can be proposed for the product architecture is proposed and documented in a DDS-Design Document Specification.

This DDS is reviewed by various stakeholders and a preferred design approach is selected based on various selection criteria (e.g., based on various parameters such as risk assessment, product robustness, design modularity, budget, and time constraints). A design approach defines the architectural modules of the product along with its communication and data flow representation with the external and third-party modules (if any).

According to some examples, in step 408, the method includes building/developing the upgrade to the network component.

According to certain non-limiting examples, in step 408 the development is performed and the product is built. The programming code is generated as per DDS during this step. Developers follow the coding guidelines defined by their organization and programming tools like compilers, interpreters, debuggers, etc. are used to generate the code. Different high-level programming languages such as C, C++, Pascal, Java and PHP are used for coding.

According to some examples, in step 410, the method includes testing the upgrade to the network component. Step 410 can include step 412. In step 412, method 100 is performed prior to deploying the new version of the network component.

According to certain non-limiting examples, step 410 can include parts of all stages of the SDLC cycle, and can thus be viewed as a subset of all the stages of the SDLC model. Further, some testing activities can be integrated with other stages of method 400. Once a code commit is ready, testing can proceed by provisioning the code commit in a staging environment that is intended to be representative of how the new version will be used in practice. Then, testing proceeds by measuring various signals to determine that the product/new version functions as desired. Generally, step 410 can include testing the product/new version for defects, bugs, or security vulnerabilities, and then reporting, tracking, fixing, and retesting the defects, bugs, or security vulnerabilities, until the product reaches the quality standards and passes a quality assurance (QA) process.

Failures (e.g., defects, bugs, or vulnerabilities) detected in the production/deployment testing (i.e., during the Verification Mode) can indicate a field escape of a bug that was missed during the QA process (e.g., the testing in step 410). To reduce the number of field escapes, step 412 provides a way to prevent the bug from negatively impacting production by doing pre-deployment testing using simulated data that is representative of the actual production environment (e.g., the customer's own data).

According to some examples, in step 414, the method includes deploying the upgrade to the network component. In step 414, the new version/product can be deployed by provisioning it in a production environment (e.g., the customer's network) and performing additional testing in this environment to ensure that the new version/product by measuring various signals to determine that the product/new version functions as desired.

A computer network is a geographically distributed collection of nodes interconnected by communication links and segments for transporting data between end nodes, such as personal computers, cellular phones, workstations, or other devices, such as sensors, etc. Many types of networks are available, with types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical light paths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to forward data from one network to another.

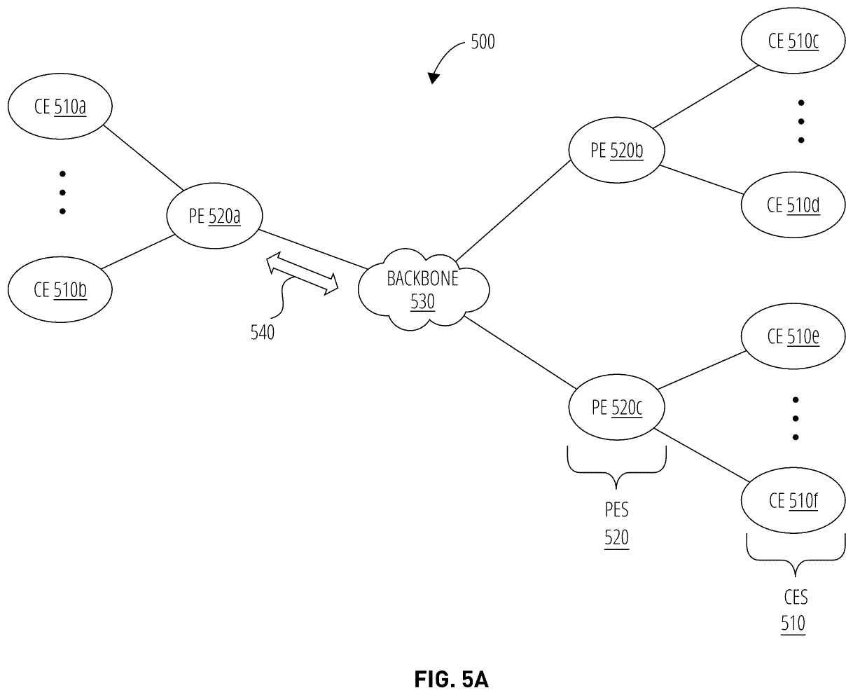

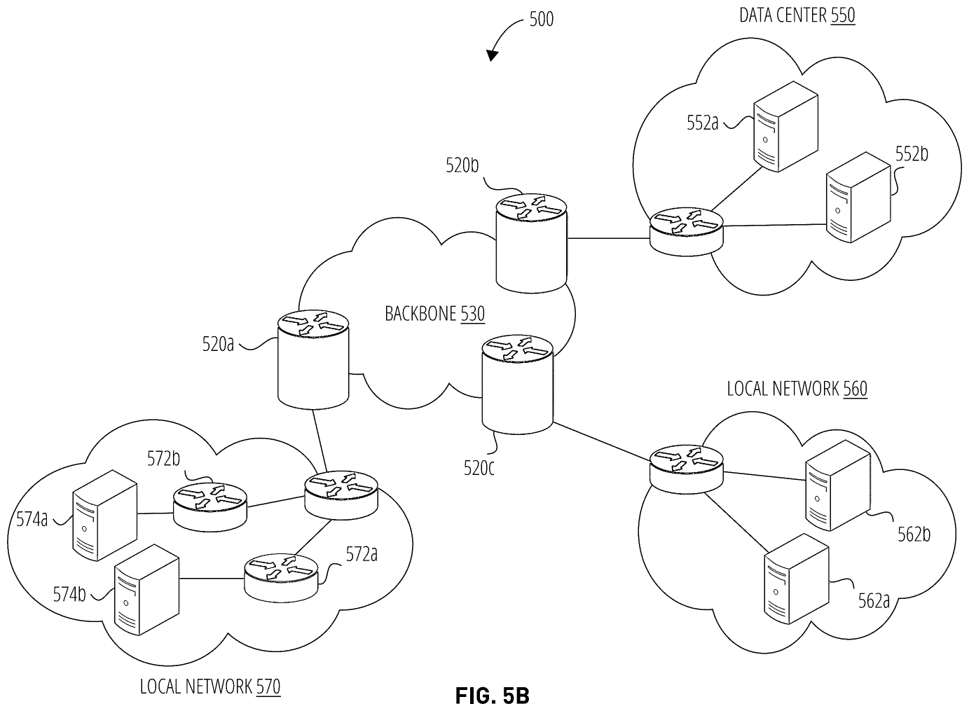

FIG. 5A is a schematic block diagram of a non-limiting example of a computer network 500 that includes various nodes/devices, such as a plurality of routers/devices interconnected by links or networks. For example, customer edge (CE) routers/devices, which are referred to collectively as CEs 510, (e.g., CE 510a, CE 510b, CE 510c, CE 510d, CE 510e, and CE 510f) may be interconnected with provider edge (PE) routers/devices, which are referred to collectively as PEs 520 (e.g., PE 520a, PE 520b, and PE 520c), to communicate across a core network, such as a network backbone 530. For example, the routers (e.g., CEs 510, PEs 520) may be interconnected by the public Internet, a multiprotocol label switching (MPLS), or a virtual private network (VPN). Data packets 540 (e.g., traffic/messages) may be exchanged among the nodes/devices of the computer network 500 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN utilizing a Service Provider network, via one or more links exhibiting very different network and service level agreement characteristics.

According to certain non-limiting examples, a given customer site may fall under one or more of the following categories:

1.) Site Type A: a site connected to the network (e.g., via a private or VPN link) using a single CE router and a single link, with potentially a backup link (e.g., a 3G/4G/5G/LTE backup connection). For example, a particular CE router shown in computer network 500 may support a given customer site, potentially also with a backup link, such as a wireless connection.

2.) Site Type B: a site connected to the network using two MPLS VPN links (e.g., from different Service Providers) using a single CE router, with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to computer network 500 via PE 520c and via a separate Internet connection, potentially also with a wireless backup link.

2c.) Site Type B3: a site connected to the network using two links connected to the public Internet, with potentially a backup link (e.g., a 3G/4G/5G/LTE connection).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router (e.g., CE 510c) connected to PE 520b and a second CE router (e.g., CE 510c) connected to PE 520c.

FIG. 5B illustrates an example of computer network 500 in greater detail, according to various embodiments. As shown, network backbone 530 may provide connectivity between devices located in different geographical areas and/or different types of local networks. For example, computer network 500 may include local network 560 having various devices/nodes (e.g., node 562a and node 562b) and local network 570 having various devices/nodes (e.g., router 572a, router 572b, node 574a, and node 574b) and devices/nodes 562a and 562b, respectively, as well as a data center 550 (or cloud environment) that includes servers 552a and 552b. Notably, local network 560, local network 570, and data center 550 can be located in different geographic locations.

Server 552a and server 552b can include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, computer network 500 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

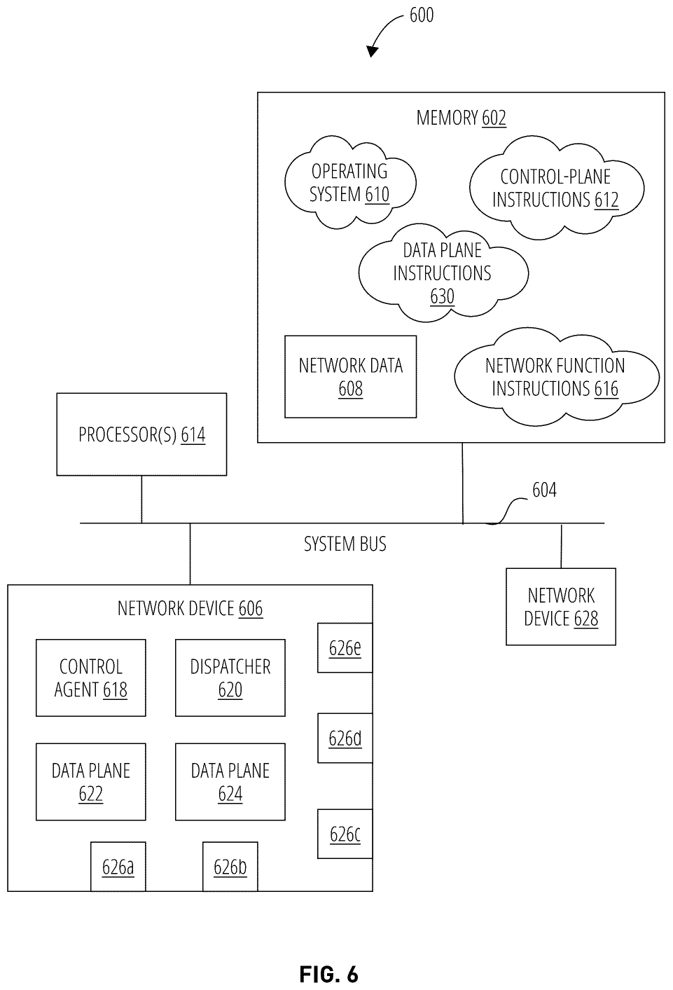

FIG. 6 is a schematic block diagram of an example device 600 (e.g., a switch, server, CPU, DPU, or combination thereof) that may be used with one or more embodiments described herein. The device 600 may also be any other suitable type of device depending upon the type of network architecture in place. For example, the device 600 can be a network component at a node in a communication network, a node in a data center network, a node in a WiFi network, or an Internet of things (IoT) node. Device 600 can include network device 606 and network device 628, one or more processor(s) 614, and a memory 602 interconnected by a system bus 604.

The network device 606 can include the mechanical, electrical, and signaling circuitry for communicating data over physical links coupled to a network. The network device 606 can be configured to transmit and/or receive data using a variety of different communication protocols. the network device 606 can also be used to implement one or more virtual network interfaces, such as for virtual private network (VPN) access, known to those skilled in the art. The network device 606 can be implemented as software instructions executed on a central processing unit (CPU), on a virtual machine (VM), on a Berkley packet filter (BPF) or extended BPF (cBPF) that is configured to implement a network policy or function, for example. Alternatively or additionally, The network device 606 can be implemented as a separate piece of hardware (e.g., a data processing unit (DPU), a graphics processing unit (GPU), a smart network interface card (SmartNIC), a network interface controller, an application-specific integrated circuit (ASIC), field programable gate array (FPGA), or other device/circuitry configured to perform the function of a network component).

The network device 606 can be configured to provide one or more security operations, including, e.g., data-packet filtering, load balancing, packet screening, pattern detection for cybersecurity threats, malware detection, firewall protection, data-packet routing, data-packet switching, data-packet forwarding, computing header checksums, or implementing network policies. The network device 606 can include (or be part of) a software-defined wide area network (SD-WAN) appliance, a firewall, or a load balancer, for example.

The network device 606 can include a data plane, a control plane, and a management plane, as discussed below. Further, control-plane instructions 612 implementing the control plane and the management plane can be stored and/or in the memory 602 and executed in the processor(s) 614. Additionally or alternatively, the network device 606 can include processors or circuits that implement one or more functions of the control plane and the management plane. The network device 606 can include a series of ports (e.g., port 626a, port 626b, port 626c, port 626d, and port 626c). The network device 606 can also include a control agent 618, a dispatcher 620, a data plane 622, and a data plane 624.

Memory 602 can include a plurality of storage locations that are addressable by the processor(s) 614 and the network device 606 for storing software programs and data structures associated with the embodiments described herein. Memory 602 can include network data 608 and can include instructions for executing operating system 610, control-plane instructions 612, network function instructions 616, and data plane instructions 630. The processor(s) 614 can include logic adapted to execute the software programs and manipulate the network data 608. An operating system 610 (e.g., the Internetworking Operating System, or IOS®, of Cisco Systems, Inc., another operating system, etc.), portions of which can be in memory 602 and executed by the processor(s), functionally organizes the node by, among other things, invoking network operations in support of software processors and/or services executing on the device.

Network device 606 and network device 628 can be configured to execute security operations, such as serverless network security operations that are in-lined in hardware. The processor(s) 614 can include a controller that determines where to provision the security operation, e.g., at which locations/nodes within the network, in which of the available network devices to provision the security operation, and/or how to provision the security operations (e.g., when the network device/component is a DPU, whether to provision the in-line in an accelerator of the DPU, in an ARM core of the DPU, in an eBPF in the ARM core, a P4 program, etc.) Additionally or alternatively, the controller can be a central controller that is located remotely from device 600.

According to certain non-limiting examples, device 600 can include the following three planes: (i) the dataplane, which processes the transit traffic; (ii) the control plane, which sends and receives control signals to monitor and control the transit traffic; and (iii) the management plane, which interacts with the user or the network management system (NMS).

Consider, For example, the operation of a router as an illustrative network edge device. Interfaces, IP subnets, and routing protocols can be configured through management plane protocols, including, e.g., a command-line interface (CLI), Network Configuration Protocol (NETCONF), and a northbound Representational State Transfer (REST) Application Programming Interface (API). The router runs control plane routing protocols (e.g., Open Shortest Path First (OSPF), Enhanced Interior Gateway Routing Protocol (EIGRP), Border Gateway Protocol (BGP), etc.) to discover adjacent devices and the overall network topology, or to discover reachability information in case of distance/path vector protocols). The router inserts the results of the control-plane protocols into Routing Information Base (RIB) and Forwarding Information Base (FIB). The dataplane software or ASICs, e.g., then use the FIB structures to forward the transit traffic. The management plane protocols (e.g., Simple Network Management Protocol (SNMP)) can then be used to monitor the device operation, its performance, interface counters, etc.

Continuing with the non-limiting example of device 600 being a router, in addition to controlling the routing protocols, the control plane protocols can also perform numerous other functions including: (i) interface state management (e.g., Point-to-Point Protocol (PPP), Transmission Control Protocol (TCP), and Link Aggregation Control Protocol (LACP)); (ii) connectivity management (e.g., Bidirectional Forwarding Detection (BFD), Connectivity Fault Management (CFM), etc.); (iii) adjacent device discovery (e.g., “hello” mechanisms present in most routing protocols, such as, End System-to-Intermediate System (ES-IS), Address Resolution Protocol (ARP), Internet Protocol version 6 (IPv6_Neighbor Discovery Protocol (NDP), Universal Plug and Play (UPnP) Simple Service Discovery Protocol (SSDP), etc.); (iv) topology or reachability information exchange (IPv6 routing protocols, Intermediate System to Intermediate System (IS-IS) in Transparent Interconnection of Lots of Links (TRILL) and Shortest Path Bridging (SPB), Spanning Tree Protocol (STP), etc.); and (v) service provisioning (e.g., Resource Reservation Protocol (RSVP) for IntServ or Traffic Engineering (TE) based on Multiprotocol Label Switching (MPLS), uPNP SOAP (Simple Object Access Protocol) calls, etc.).

Still continuing with the non-limiting example of device 600 being a router, in addition to forwarding packets, the dataplane can also perform the following functions: (i) network address translation (NAT) session creation and NAT table maintenance; (ii) neighbor address gleaning (e.g., dynamic Media Access Control (MAC) address learning in bridging, IPv6 Source Address Validation Improvement (SAVI), etc.); (iii) NetFlow or sampled flow (sFlow) accounting; (iv) network access control list (ACL) logging; and (v) Error signaling, such as Internet Control Message Protocol (ICMP).

According to certain non-limiting examples, device 600 can configure a data plane to perform various security operations including, but not limited to, applying 5-tuple rules, data-packet filtering, load balancing, security screening, malware detection, firewall protection, data-packet routing, data-packet switching, data-packet forwarding, computing header checksums, or implementing network policies. Security screening can include, but is not limited to, deep packet inspections, analysis of behavioral graphs for detection of cyber attacks and/or malicious software, anomaly detection, cyber-attack signature detection, packet filtering, intrusion prevention systems, extended detection and response, endpoint detection and response, and/or network detection and response functions.

According to certain non-limiting examples, the management and control planes can be implemented in a central processing unit (CPU) or in a data processing unit (DPU). According to certain non-limiting examples, the data plane could be implemented in numerous ways, including, e.g.: (i) as optimized code running on the same CPU as the control plane; (ii) as code running on a dedicated CPU core (e.g., a dedicated CPU for high-speed packet switching, such as a Linux server); (iii) as code running on linecard CPUs (e.g., a CISCO 7200 series router); (iv) as dedicated processors (e.g., network process units (NPUs), data process units (DPUs), smart network interface cards (SmartNICs), etc.); and (v) as switching hardware (application-specific integrated circuits (ASICs), field programable gate arrays (FPGAs), etc.); and (vi) as switching hardware on numerous linecards.

According to certain non-limiting examples, the dataplane receives and processes the ingress packets. Further, the dataplane can selectively forward packets destined for the router (e.g., Secure Shell (SSH) traffic or routing protocol updates) or packets that need special processing (e.g., IP datagrams with IP options or IP datagrams that have exceeded their TTL) to the control plane.

According to certain non-limiting examples, the management ports on some devices (e.g. data center switches) can be connected directly to a control-plane CPU and thus bypass a switching ASIC.

According to certain non-limiting examples, the control plane can pass outbound packets to the data plane, or use its own forwarding mechanisms to determine the outgoing interface and the next-hop router (e.g., when using the local policy routing).

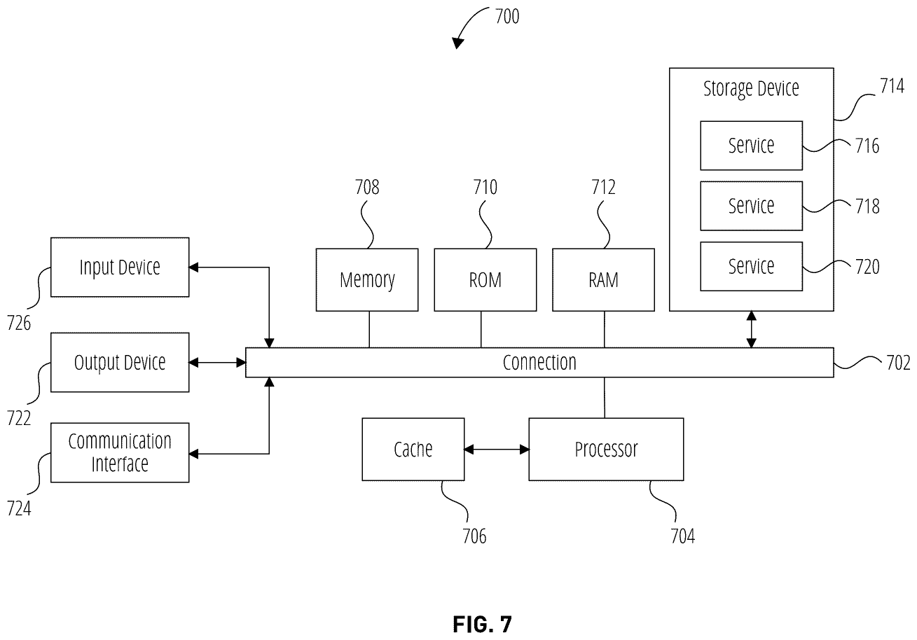

FIG. 7 shows an example of computing system 700. The computing system 700 can be a computing device making up computer network 500, device 600, or any component thereof. The computing system 700 can perform the functions of one or more of method 100 and/or method 400. The computing system 700 can be part of a distributed computing network in which several computers perform respective steps in method 100 and/or method 400 and/or the functions of device 600. The computing system 700 can be connected to the other parts of the distributed computing network via connection 702 or communication interface 724 Connection 702 can be a physical connection via a bus, or a direct connection into processor 704, such as in a chipset architecture. Connection 702 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU or processor) processor 704 and connection 702 that couples various system components including system memory 708, such as read-only memory (ROM) such as ROM 710 and random access memory (RAM) such as RAM 712 to processor 704. Computing system 700 can include a cache of high-speed memory cache 706 connected directly with, in close proximity to, or integrated as part of processor 704.

Processor 704 can include any general-purpose processor and a hardware service or software service, such as service 716, service 718, and service 720 stored in storage device 714, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

storage device 714 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

The storage device 714 can include software services, servers, services, etc., that when the code that defines such software is executed by the processor 704, it causes the system to perform a function. In some embodiments, a hardware service that performs a particular function can include the software component stored in a computer-readable medium in connection with the necessary hardware components, such as processor 704, connection 702, output device 722, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a network devices and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in the memory of a client device and/or one or more servers of a system and performs one or more functions when a processor executes the software associated with the service. In some embodiments, a service is a program or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-logic instructions that are stored or otherwise available from computer readable media. Such instructions can comprise, For example, instructions and data that cause or otherwise configure a general-purpose computer, special-purpose computer, or special-purpose processing device to perform a certain function or group of functions. Portions of computer resources used can be accessible over a network. The computer logic instructions may be, For example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method of testing versions of a network components, the method comprising:
obtaining a first flow table based on measured data, the first flow table having been generated using a first version of a network component;
generating, for respective entries in the first flow table, corresponding entries in a second flow table, the corresponding entries being identified by header information, and the corresponding entries representing a response of a second version of the network component to simulated traffic comprising data flows having the header information of the corresponding entries;
comparing the first flow table with the second flow table to generate comparison results; and
evaluating whether the second version of the network component can be deployed based on the comparison results.

2. The method of claim 1, wherein:
the header information includes a pair of a source address and a destination address, and
the simulated traffic is randomly sampled from the measured data and is sampled based on a statistical profile of the measured data.

3. The method of claim 1, wherein comparing the first flow table with the second flow table includes that each of the comparison results is a comparison result of an entry of the respective entries in the first flow table with a corresponding entry in the second flow table.

4. The method of claim 1, further comprising:
acquiring the measured data flows from a production environment;
obtaining an acquired flow table that includes the respective entries corresponding to the header information in the measured data identifying types of data flows;
generating the respective entries of the first flow table using the simulated traffic for an entry, and generating first statistics and first metadata for the entry based on a response of the first version of the network component to the simulated traffic; and
generating the corresponding entries in the second flow table by generating second statics and second metadata for the corresponding entries based on the response of the second version of the network component to the simulated traffic.

5. The method of claim 1, wherein generating the corresponding entries in the second flow table further includes ensuring correctness of the corresponding entries using additional data collected from the network component, wherein the additional data includes DNS cache data mapping symbolic names to IP addresses and/or operations performed at open systems interconnection (OSI) layer seven (L7).

6. The method of claim 1, wherein the first flow table and the second flow table include entries for both allowed packets and denied packets.

7. The method of claim 1, wherein each entry in the first flow table and the second flow table includes fields for a source, a destination, whether data packets were allowed or denied, metadata, and statistics.

8. The method of claim 1, wherein the first flow table and the second flow table include entries for dropped packets, blocked packets, and/or restricted packets.

9. The method of claim 1, wherein:
when the network component operates at open systems interconnection (OSI) layer two (L2), the header information includes a source address and a destination address that are media access control (MAC) addresses,
when the network component operates at OSI layer three (L3), the header information includes that the source address and the destination address are internet protocol (IP) addresses, and/or
when the network component operates at OSI layer four (L4), the header information includes that the source address and destination address are MAC addresses and/or IP addresses, and the first flow table and the second flow table can include a field for a connection state.

10. The method of claim 1, wherein comparing the first flow table with the second flow table includes:
comparing whether decisions made for a flow-table entry are consistent between the first flow table and the second flow table,
comparing processing resources used for the decisions between the first flow table and the second flow table, and/or
comparing performance statistics between the first flow table and the second flow table.

11. The method of claim 1, evaluating whether the second version of the network component can be deployed includes:
preventing the second version of the network component from being deployed when the comparison results indicate a degradation in performance statistics of the second version of the network component relative to the first version of the network component, and/or
preventing the second version of the network component from being deployed when one or more inconsistencies between an expected characteristic of egress packets from the second version of the network component relative to an actual characteristic of egress packets from the second version of the network component.

12. The method of claim 1, wherein the network component is one or more devices and/or circuitry executing instructions that perform a network function, the instructions being executed in a control plane and/or a data plane, and the instructions including policies, software, and/or firmware.

13. An apparatus comprising:
a processor; and
a memory storing instructions that, when executed by the processor, configure the apparatus to:
obtain a first flow table based on measured data, the first flow table having been generated using a first version of a network component;
generate, for respective entries in the first flow table, corresponding entries in a second flow table, the corresponding entries being identified by header information, and the corresponding entries representing a response of a second version of the network component to simulated traffic comprising data flows having the header information of the corresponding entries;
comparing the first flow table with the second flow table to generate comparison results; and
evaluate whether the second version of the network component can be deployed based on the comparison results.

14. The apparatus of claim 13, wherein:
the header information includes a pair of a source address and a destination address, and
the simulated traffic is randomly sampled from the measured data and is sampled based on a statistical profile of the measured data.

15. The apparatus of claim 13, wherein configuring the apparatus to compare the first flow table with the second flow table includes that each of the comparison results is a comparison result of an entry of the respective entries in the first flow table with a corresponding entry in the second flow table.

16. The apparatus of claim 13, wherein the instructions further configure the apparatus to:
acquire the measured data flows from a production environment;
obtain an acquired flow table that includes respective entries corresponding to header information in the measured data identifying types of data flows;
generate the respective entries of the first flow table using the simulated traffic for an entry, and generating first statistics and first metadata for the entry based on a response of the first version of the network component to the simulated traffic; and
generate the corresponding entries in the second flow table by generating second statics and second metadata for the corresponding entries based on the response of the second version of the network component to the simulated traffic.

17. The apparatus of claim 13, wherein the instructions configure the apparatus to generate the corresponding entries in the second flow table by configuring the apparatus to ensure correctness of the corresponding entries using additional data collected from the network component, wherein the additional data includes DNS cache data mapping symbolic names to IP addresses and/or operations performed at open systems interconnection (OSI) layer seven (L7).

18. The apparatus of claim 13, wherein the first flow table and the second flow table include entries for both allowed packets and denied packets.

19. The apparatus of claim 13, wherein:
the first flow table is for processing data flows at open systems interconnection (OSI) layer two (L2), and a source address field and a destination address field for each entry in the first flow table and in the second flow table are media access control (MAC) addresses,
the first flow table is for processing data flows at OSI layer three (L3), and the source address field and destination address field are internet protocol (IP) addresses, and/or
the first flow table is for processing data flows at OSI layer four (L4), the source address field and destination address field are MAC addresses and/or IP addresses, and the first flow table and the second flow table can include a field for a connection state.

20. A non-transitory computer-readable storage medium, the non-transitory computer-readable storage medium including instructions that when executed by a computer, cause the computer to:
obtain a first flow table based on measured data flows, the first flow table having been generated using a first version of a network component;
generate, for respective entries in the first flow table, corresponding entries in a second flow table, the corresponding entries being identified by header information, and the corresponding entries representing a response of a second version of the network component to simulated traffic comprising data flows having the header information of the corresponding entries;
comparing the first flow table with the second flow table to generate comparison results; and
evaluate whether the second version of the network component can be deployed based on the comparison results.
